(19) United States
(12) Patent Application Publication
(10) Pub. No.: US 2014/0337674 A1
(43) Pub. Date: Nov. 13, 2014

(54) Network Testing

(71) Applicant: NEC Laboratories America, Inc., Princeton, NJ (US)

(72) Inventors: Franjo Ivancic, Princeton, NJ (US); Cristian Lumezanu, East Windsor, NJ (US); Gogul Balakrishnan, Princeton, NJ (US); Willard Dennis, Lawrenceville, NJ (US); Aarti Gupta, Princeton, NJ (US)

(73) Assignee: NEC Laboratories America, Inc., Princeton, NJ (US)

(21) Appl. No.: 14/270,445

(22) Filed: May 6, 2014

Related U.S. Application Data
(60) Provisional application No. 61/821,796, filed on May 10, 2013.

(51) Int. Cl. H04L 12/26

(52) U.S. Cl. CPC H04L 43/50
USPC 714/43

(57) ABSTRACT

A network testing method implemented in a software-defined network (SDN) is disclosed. The network testing method comprising providing a test scenario including one or more network events, injecting said one or more network events to the SDN using an SDN controller, and gathering network traffic statistics. A network testing apparatus used in a software-defined network (SDN) also is disclosed. The network testing apparatus comprising a testing system to provide a test scenario including one or more network events, to inject said one or more network events to the SDN using an SDN controller, and to gather network traffic statistics. Other methods, apparatuses, and systems also are disclosed.

This application claims the benefit of U.S. Provisional Application No. 61/821,796, entitled “SDTN: Software-Defined Testing Network,” filed on May 10, 2013, the contents of which are incorporated herein by reference.

### BACKGROUND OF THE INVENTION

The present invention relates to network testing and, more particularly, to network testing of a software-defined network (SDN).

The recent emergence of cloud computing—the use of hardware or software computing resources over a network such as the internet—has led to new opportunities for large-scale systems such as Big Data applications. End users of cloud-based applications often entrust the user's data to remote services by software and infrastructure providers. For example, in the Software as a Service (SaaS) business model, the end user typically accesses the on-demand provided software through a thin client via a web browser, while the user's data is stored at the application-service provider. According to a recent estimate, SaaS sales reached $10 billion in 2010, and are projected to double by 2015. The rapid growth of this business model is partially explained by the ease of deployment of applications, resiliency of a deployed system through fault tolerance, performance, scalability and elasticity.

However, testing cloud/distributed applications faces major new challenges: Cloud applications are an intricate combination of complex and dynamically changing components such as virtual machines (VMs), servers and services that communicate through a potentially wide-area, unreliable and uncontrollable network connection such as the internet. Systematic testing of interactions between complex components is non-trivial.

We consider the problem of testing a distributed cloud application for resilience and performance against network congestion and network connection loss. Rather than mimicking real-world network traffic through arbitrary background traffic, or wide-area network emulators such as Dummynet, netem, NISTNet or WANem, we propose to utilize the framework of software-defined networking (SDN) for this task.

SDN is often considered as an essential building block in virtualizing networks. Here, we propose to use SDNs to help test distributed applications in a controlled, but real test environment, by controlling and forcing hard-to-capture network degradations in the wild. We stress that the main difference between this approach and the well-studied use of network emulators is that all data traffic actually flows through a real software-defined network such as an OpenFlow network, rather than through simulations or emulations of modeled communication links.

Related art on large-scale distributed cloud application testing has focused on two distinct testing goals: Testing for resilience and robustness to failures, and testing for performance. One approach is to use stress testing, which has been used for both goals. In stress testing, the application is put in a test environment under a heavy load situation and performance and robustness are inspected. For this, one needs to somehow create network traffic and conditions with heavy loads.

In the realm of performance testing, network emulators have been used to allow testing of network performance in a potentially stressed environment without having to actually stress the network. This requires a model of the network that can be used for network emulations.

In the realm of resiliency and robustness testing, fault injection-based techniques are frequently used to test distributed applications. These faults are generally injected by forcing certain events (such as prematurely terminating instances of a running distributed service as in chaos monkey testing).

We observe the effects of network failures on the distributed applications without having to actually stress a real network. Furthermore, for effectiveness of testing and improved tester productivity, we want to avoid modifying the applications being tested. Instead, we propose to use SDNs to help test distributed applications in a controlled, but real test environment, by controlling and forcing hard-to-capture network degradations in the wild. We stress that the main difference between this approach and the well-studied use of network emulators is that all data traffic actually flows through a real software-defined network such as an OpenFlow network, rather than through simulations or emulations of modeled communication links.

The key idea of our approach is to utilize the programmability of the SDN controller to provide an easy-to-control network virtualization layer that cloud system testers can use to test their cloud applications, for resilience to network failures such as network traffic spikes, congestion, connection loss, etc. In our approach, the SDN controller exercises control over all installed network traffic rules on the switches to purposefully inject such network failures and to monitor network-level events. We posit that this approach could be extended to perform performance testing of distributed applications, by building upon some of the advance features of modern network emulators.

Our main goal is to allow effective testing of modern distributed cloud services that rely on network communication. Many robustness issues of such distributed services are likely due to communication issues that are simply hard to test in the current standard test environments, which generally consist of a test server hosting many VMs. From an application testers' perspective, we offer to lift the network virtualization capability of software-defined networking to her, so that she can easily focus on her task of testing interesting scenarios rather than on modeling the actual network conditions precisely.

Finally, we note that we propose the use of OpenFlow for distributed cloud application testing in an OpenFlow test network environment. However, this does not mean that the final deployed distributed application requires an OpenFlow-enabled network. Note that we use the OpenFlow-enabled network just as a way for a tester to control the network in an efficient manner with respect to the testing priorities and policies. In other words, the final deployed application may or may not use an OpenFlow-enabled network.

Cost of testing is lowered since a testbed is built using open-source components only, or it can be used in a live SDN already in use, by creating a separate virtual slice for testing.

Complexity and effort of setting up a test environment are also reduced, since it does not require defining low-level network characteristics/conditions as needed by network emulators. This also improves tester productivity.

### REFERENCES

[1] M. Canini, D. Venzano, P. Pere\check{s}íni, D. Kostic', and J. Rexford. Automating the testing of OpenFlow applications. In NSDI. USENIX, 2012.
[2] M. Carbone and L. Rizzo. Dummynet revisited. Computer Communication Review, 40(2):12-20, 2010.
[3] N. Foster, R. Harrison, M. J. Freedman, C. Monsanto, J. Rexford, A. Story, and D. Walker. Frenetic: A network programming language. In IFIP. ACM, 2011.
[4] H. S. Gunawi, P. Joshi, P. Alvaro, J. Yun, J. M. Hellerstein, A. C. Arpaci-Dusseau, and R. H. Arpaci-Dusseau. FATE and DESTINI: A framework for cloud recovery. In NSDI, 2011.
[5] P. Joshi, H. S. Gunawi, and K. Sen. PREFAIL: A programmable tool for multiple-failure injection. In OOPSLA, pages 171-188. ACM, 2011.
[6] M. Kuz'niar, P. Pere\check{s}íni, M. Canini, D. Venzano, and D. Kostic'. A SOFT way for OpenFlow switch interoperability testing. In CoNEXT, 2012.
[7] R. Lübke, R. Lungwitz, D. Schuster, and A. Schill. Emulation of complex network infrastructures for large-scale testing of distributed systems. In WWW/Internet. IADIS, 2012.
[8] P. D. Marinescu and G. Candea. Efficient testing of recovery code using fault injection. ACM Trans. Comput. Syst., 29(4):11, 2011.
[9] N. McKeown, T. Anderson, H. Balakrishnan, G. Parulkar, L. Peterson, J. Rexford, S. Shenker, and J. Turner. OpenFlow: Enabling innovation in campus networks. SIGCOMM Comp. Comm. Review, 38(2), 2008.
[10] C. Monsanto, N. Foster, R. Harrison, and D. Walker. A Compiler and Run-time System for Network Programs. In POPL. ACM, 2012.
[11] M. Nambiar and H. K. Kalita. Design of a new algorithm for WAN disconnection emulation and implementing it in WANem. In ICWET, pages 376-381. ACM, 2011.
[12] L. Nussbaum and O. Richard. A comparative study of network link emulators. In SpringSim. SCS/ACM, 2009.
[13] C. Rotsos, N. Sarrar, S. Uhlig, R. Sherwood, and A. Moore. OFLOPS: An open framework for OpenFlow switch evaluation. In PAM, 2012.
[14] B. White, J. Lepreau, L. Stoller, R. Ricci, S. Guruprasad, M. Newbold, M. Hibler, C. Barb, and A. Joglekar. An integrated experimental environment for distributed systems and networks. In OSDI, 2002.
[15] A. Wundsam, D. Levin, S. Seetharaman, and A. Feldmann. OFRewind: Enabling record and replay troubleshooting for networks. In ATC, 2011.

### BRIEF SUMMARY OF THE INVENTION

An objective of the present invention is to lower the cost of testing a network. The present invention also reduces complexity and effort of setting up a test environment.

An aspect of the present invention includes a network testing method implemented in a software-defined network (SDN). The network testing method comprises providing a test scenario including one or more network events, injecting said one or more network events to the SDN using an SDN controller; and gathering network traffic statistics.

Another aspect of the present invention includes a network testing apparatus used in a software-defined network (SDN). The network testing apparatus comprises a testing system to provide a test scenario including one or more network events, to inject said one or more network events to the SDN using an SDN controller, and to gather network traffic statistics.

### BRIEF DESCRIPTION OF THE DRAWINGS

FIG. 1 depicts a Conceptual test view.

FIG. 2 depicts a static flow rule for ZooKeeper testing.

FIG. 3 depicts a command to remove ZooKeeper testing rule.

FIG. 4 depicts network topology of the testbed.

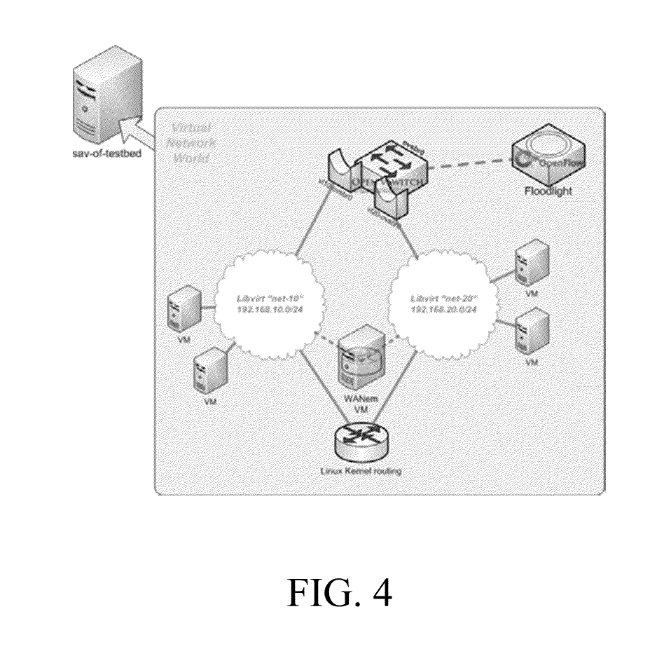

FIG. 5 depicts a NULL pointer bug in ZooKeeper.

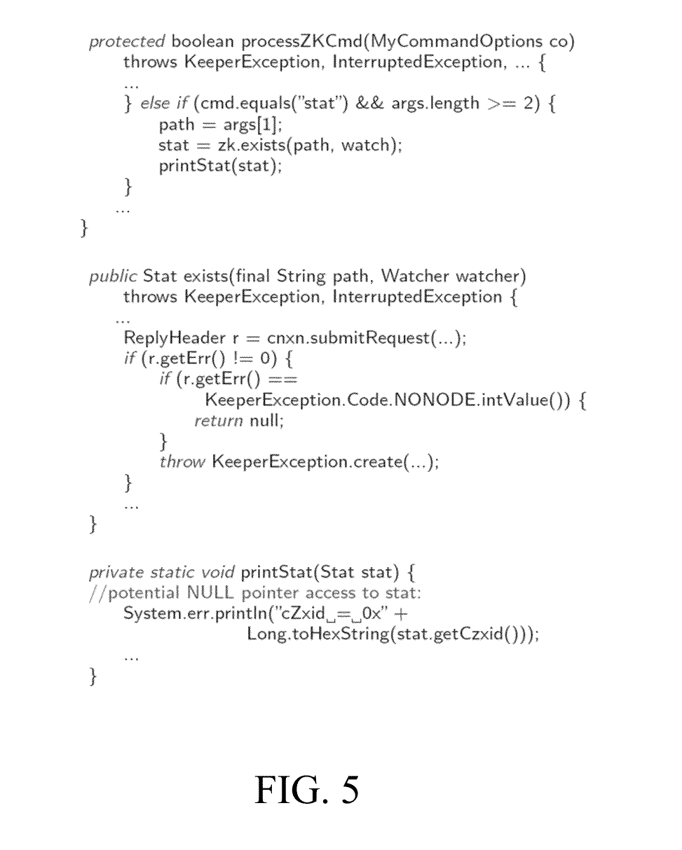

FIG. 6 depicts combining OpenFlow-based testing with network emulators.

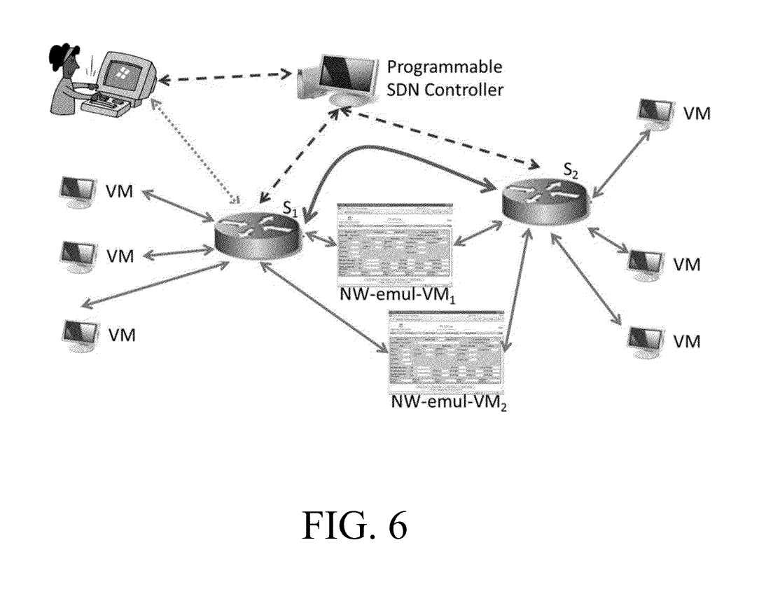

### DETAILED DESCRIPTION

We are interested in finding issues in distributed cloud applications and services with respect to network communication degradations such as failures or congestions. We assume that the service is distributed on a number of virtual machines (VMs). The tester uses a software-defined network to control network events and communication links between the distributed application running on several VMs. We use a programmable controller. In the following picture we show a conceptual view of the test network consisting of a programmable software-defined networking controller, two switches S₁ and S₂, and several VMs denoting the distributed application.

The tester provides a high-level test scenario description, which includes relevant events in the distributed application and relevant events in the controlled network. For example, the tester has a particular work load that is used for testing, and also specifies what type of network events should occur at various stages of the execution of the distributed application. These network events relate to network connection loss or network connection degradations. The test system dynamically injects these network events using an SDN controller such as through the OpenFlow application programming interface (API).

The advantage of using a full network for testing is that it allows us to test the actual application in a realistic network environment rather than just in an emulated environment. Furthermore, the executed tests can run in a dynamically changing network environment rather than a static emulation setting.

It may also be possible to use some of the advanced capabilities provided by network emulators in an SDN-based test network. One such use case would be to configure certain network characteristics captured within several instances of network emulators, and have the SDN-based test network dynamically change which traffic to route through these configured sub-network emulators. For example, as shown in the next picture, we may consider having three paths between switches S₁ and S₂. The three paths would have different network characteristics which could be pre-configured with specialized network emulator VMs, or could be dynamically adaptable.

There are different use cases for such a combination of programmable network control with network emulators. First, we can utilize this approach as an extension of distributed application testing. This would let the tester check for the application robustness and performance given certain emulated network conditions.

A second use case is to allow network emulators better scalability by distributing their workload onto multiple servers connected through an actual network. Network emulators still face performance bottlenecks in estimation of network effects in high data rate emulations. By distributing the emulation to various servers, the emulation performance can be increased. The additional advantage of using this in the context of SDNs is that we can design a programmable SDN module that monitors the performance of the distributed emulation. Furthermore, the SDN module can act as a load balancer for network emulators by adapting flows to underutilized emulation servers.

We also observe that OpenFlow allows network traffic statistics generation on individual switches, which are communicated to the OpenFlow controller. This information, in conjunction with the fact that the controller can choose desired lifetime lengths of installed rules, can be utilized by the tester for debugging purposes as well. For example, the tester can gather network-level statistics about how often a distributed application tried to connect to a certain port on different destination hosts.

Further System Details

Distributed cloud applications are an intricate combination of complex and dynamically changing components, that communicate through an unreliable and uncontrollable network connection. Thus, testing such applications and services in a systematic fashion is non-trivial. We show how to use software-defined networks (SDNs) to effectively test distributed applications for resilience to network issues such as communication delays. We rely on the programmability aspect of SDNs to virtualize the network to the tester. We present a promising initial implementation of these ideas using OpenFlow API.

1 Introduction

Cloud computing—the on-demand use of remote hardware or software computing resources over a network—has emerged as the de facto way of deploying new applications and services at scale. Applications and data reside on the cloud provider infrastructure and are accessed by users over the Internet using a web browser or thin client. According to a recent estimate, the sales of Software as a Service (SaaS), one of the most popular cloud-service models, reached $10 billion in 2010, and are projected to double by 2015.

Effective diagnosis of abnormal behavior is essential for maintaining availability and controlling costs of cloud-based applications. Operational problems can have severe financial or availability implications. A recent study showed that every minute of outage costs US-based providers on average $5,600 (see http://tinyurl.com/cc23gb7). Anecdotal evidence suggests that the April 2011 AWS service outage cost Amazon around $2 million in revenue loss (see http://tinyurl.com/brvt5ox).

However, testing cloud applications and services is challenging. First, such applications contain complex and dynamic components with unpredictable interactions between them. In addition, these components are distributed across VMs and servers in the cloud and communicate among them and with the users through an unreliable network. For example, the aforementioned Amazon outage appears to have been caused by a networking event that triggerd repeated backups of the same data (see http://tinyurl.com/43tooca). Ideally, any service should be resilient to any networking event.

Second, for accuracy and completeness, testing distributed cloud applications should cover a wide range of realistic testing scenarios. Testing applications under their natural environment, i.e., the unreliable and best-effort Internet, is ideal but difficult because it is impossible to control network conditions to generate various testing scenarios. As a result, researchers have resorted to network emulators and simulators. Such tools enable fine-grained control over network behavior and properties (e.g., delay, loss, packet reordering, etc.) but focus on accurate network protocol emulations rather than testing distributed applications. In addition, setting up a realistic emulation is not trivial because it requires abstractions and approximations of the real network and because it may not scale under certain scenarios (e.g., high data rates) [12].

We propose to use the framework of software-defined networks (SDN) to test distributed cloud applications for resilience against communications issues, such as network congestion and loss. We do not specifically address hardware fault-tolerance. However, given that many applications are distributed, hardware failures affecting some hosts often result in communication delays or failures for other hosts. SDNs allow operators and administrators to manage the network from a centralized server and provides both the control and the coverage necessary to perform cloud testing. Similarly to network emulators, testers have control over network properties (by installing forwarding rules that direct, drop, or delay traffic), but unlike emulators, the testing occurs in a real network and does not require generating network traffic and simulating its properties and behavior.

Software-defined networking enables us to build a testing network that is completely under control of the tester. The tester uses the centralized controller to configure the network with forwarding rules based on high-level testing goals, to inject network failures, and to monitor network-level statistics. For example, to test an application for reliability against partial connection loss, the controller can temporarily remove the rules that forward traffic towards the application nodes.

We build our testing network using OpenFlow [9], the most popular SDN protocol. OpenFlow is enabled in hardware switches offered by many vendors, including Cisco, IBM, Juniper, and NEC, and in software switches such as the Open vSwitch (see openvswitch.org). Furthermore, there are a number of open-source OpenFlow controllers available, including NOX, PDX (see http://www.noxrepo.org), and FloodLight (http://www.projectfloodlight.org), amongst others. We also emphasize that, although we propose to use OpenFlow to test cloud applications, the deployed applications do not require OpenFlow or any other SDN protocol to run.

Contributions.

Our contributions are, for example:
We propose to use an OpenFlow-enabled test network to test for resilience of distributed cloud applications to network stress and connection failures.
We show how a tester may utilize such an environment for efficient testing of cloud applications by presenting an implementation using open-source components.
We present initial promising experiments on such an OpenFlow-enabled network test environment for some popular distributed services and applications.

Overview.

First, we present some relevant background on OpenFlow and network emulators in Section 2. Then, Section 3 introduces desired aspects of a cloud application testing framework. Section 4 discusses our OpenFlow-based test framework. In Section 5, we showcase some early promising experimental results using our approach. Next, we discuss additional related work in Section 6. Finally, Section 7 ends with a discussion of the proposed framework and directions.

2 Background

2.1 OpenFlow

Software-defined networking separates the control plane from the data plane in a network. The control plane resides on a logically centralized server (the controller), while the fast data plane remains on the network switches. The controller enforces network administrator policies by translating them into low-level configurations and inserting these dynamically into switch flow tables using an API such as OpenFlow.

A network's configuration consists of the forwarding rules installed at the switches. Every rule consists of matching entries that specify which packets match a rule, an action to be performed on matched packets, and a set of counters (which collect statistics). Possible actions include “forward to output port”, “forward to controller”, “drop”, etc. The controller uses a specialized control packet, called FlowMod, to insert a rule into a switch's data plane.

Rules can be installed proactively (i.e., at the request of the application or operator) or reactively (i.e., triggered by a PacketIn message as described below). Rules can be matched based on many parameters of a packet header, including the source and destination IP addresses or media access control (MAC) addresses, port numbers used for communication, type of communication protocol used, etc. The OpenFlow network operates in the following (simplified) way.

On the arrival of the first packet of a new flow (i.e., a sequence of packets from a source to a destination), the switch looks for a matching rule in the flow table and performs the associated action. If there is no matching entry, the switch buffers the packet and notifies the controller that a new flow has arrived by sending a PacketIn control message containing the headers of the packet. The controller responds with a FlowMod message that contains a new rule matching the flow that is to be installed in the switch's flow table. The switch installs the rule and forwards the buffered and subsequent flow packets according to it.

TABLE 1
A simplified OpenFlow flow entry table

| Priority | src-IP | dest-IP | action |
|---|---|---|---|
| 17 | 192.168.10.10 | * | out port 3 |
| 12 | 192.168.10.* | * | out port 7 |
| 5 | 192.168.*.* | 192.168.10.5 | drop |

### Example 1

Consider the simplified flow entry table presented in Table 1. It only shows rule matches based on the IP addresses of the sending host and the destination host. We assume that all other rule components are wildcard matches in this example. Each rule has a priority, which decides the order of processing. When a new packet arrives at a switch configured in this way, the rule with priority 17 will be analyzed first. If the packet originated at 192.168.10.10, the switch forwards it to port 3. However, if the packet originated from any other IP with prefix 192.168.10, then the packet is sent to port 7. If neither rule matches the incoming packet, and the packet originated at a host with IP prefix 192.168 and destination 192.168.10.5, the last rule is used to drop the packet. This could be for reasons of SPAM removal or firewall related issues. Finally, if none of the installed rules matches the incoming packet, the switch creates a PacketIn message to be sent to the controller for further processing.

2.2 Network Emulators

Network simulators and network emulators have been investigated for the past two decades for protocol-level performance testing. The Linux kernel provides the netem package (see http://tinyurl.com/25uxcbo), which is a network emulation functionality that allows protocol testing by emulating different properties of wide area networks. WANem [11] provides a browser-based GUI to control netem. It also provides some standard connection metrics such as bandwidth for well-known communication standards or connection cables. Dummynet [2] is another popular emulator. There are also large-scale emulation environments such as Emulab [14].

Network emulators are used to model the behavior of wide-area networks using a simulated network, which a user controls using information such as bandwidth, capacities, roundtrip packet propagation delays, and other parameters related to networks and traffic shaping. It was shown that network emulators can estimate the performance of protocols very well, although they may face scalability issues, especially when emulating high data rates [12]. In addition, network emulators often allow specification of other possible network effects such as packet loss, packet duplication, packet re-ordering, etc. Although our testing framework does not specifically test against these events, we believe it can effectively replicate their effect by degrading network performance.

Furthermore, setting up a realistic emulation model is non-trivial and contains abstractions and approximations of the real network and traffic management. In order to perform a realistic network emulation, we may need to generate realistic background network traffic to model potentially congested network conditions. Instead, our approach allows fine-grained testing in a real (OpenFlow) network with actual switches, and with actual background traffic in a live network.

3 Cloud Application Testing

In this section, we present our SDN-based test network framework for testing of distributed applications. A conceptual test environment overview is shown in FIG. 0. The distributed application runs on a number of connected VMs, depicted in the figure as connected through two switches S₁ and S₂. The control plane of the network is shown in red (dashed lines), while the data plane is shown in blue (solid lines). The tester can create work-loads for the distributed application (dotted green line). However, the tester also controls the OpenFlow controller by programming it to install rules that manage or shape the traffic for some network test scenarios.

3.1 Resiliency Test Requirements

There are a number of features that a distributed application testing framework needs to support. At a high level, we can distinguish between tests for functional correctness, performance (and other non-functional requirements), and resiliency of the application to network/communication latencies and loss. Our main focus is on resiliency of the application to communication bottlenecks. Therefore, the test framework should have the following capabilities:

1. Network-Based Resiliency-Related Scenarios:
(a) Throttling or link failure of switch-level traffic on central communication links, e.g. between routers
(b) Throttling or link failure of application messages only (application-level degradation)
(c) Throttling or link failure of all traffic between two VMs (localized, or VM-level degradation)
(d) Throttling or link failure of localized application-level communication between two VMs
(e) Network monitoring capabilities for messages in the distributed system under test

2. VM-Based Resiliency-Related Scenarios
(a) Health monitoring and logging of the distributed service or application
(b) High-level control of application such as shutdown of component, shutdown of VM, etc.

3. Work-Load Generation

4. Dynamic and Fast Changes of Network Conditions

Since we focus on testing cloud applications with respect to network communication failures and congestions, we assume that the tester has relevant test scenarios in mind. Thus, we will not discuss further the capabilities mentioned above in (2) and (3). In Section 4, we show how SDN can naturally provide features (1) and (4).

3.2 Defect Types

Similar to other testing strategies such as stress testing and fault-injection based testing, this approach can discover a variety of defects. These range from high-level design mistakes where desired properties are not maintained, to low-level coding bugs such as NULL-pointer exceptions. Our tests do not target any observed defect type in particular. We leverage any testing policy that is used, including any existing tests and monitors or health checks. Crashes and other visible defects reported in logs are easy to detect.

4 OpenFlow-Based Test Framework

In this section we present two SDN modules that enable dynamic and fast changes of network conditions by dropping, degrading, or rerouting communication flows. These modules offer a natural way to satisfy the test features (1) and (4) in Section 3. Both modules are implemented under the open-source FloodLight OpenFlow controller: static flow pusher comes with FloodLight and flow delay was developed by us.

4.1 Static Flow Pusher Module

The static flow pusher module allows a network administrator to insert forwarding rules into an OpenFlow network. This module is typically used based on a priori (or out-of-band) knowledge of incoming flows, and thus allows to proactively install rules on switches before such packets arrive. This module is exposed to the administrator through a REST API and, for each request, generates FlowMod packets that communicate the desired rule change to the OpenFlow switch.

### Example 2

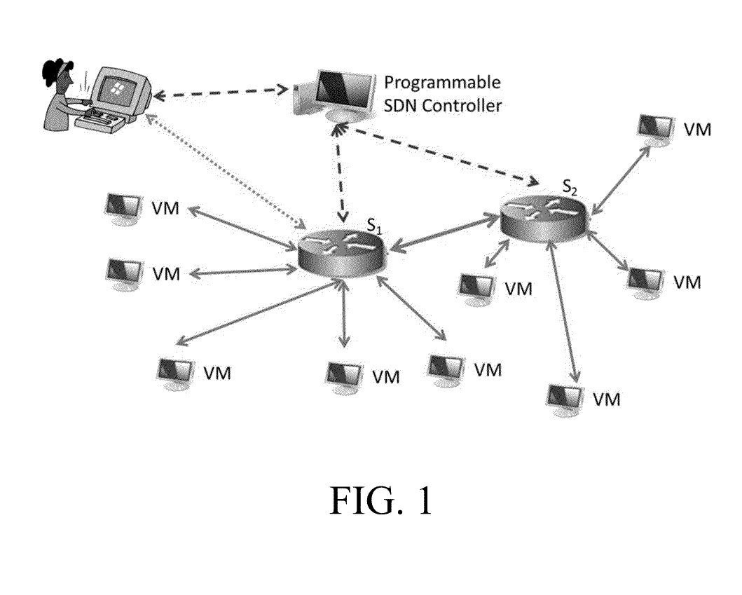

Consider the case where the tester analyzes the distributed service ZooKeeper (see http://zookeeper.apache.org). FIG. 1 shows a sample curl command that the tester can issue to the static flow entry pusher module. Here we model the effect of a bad connection from a particular source VM. As shown, the rule only matches on TCP packets (protocol 6), and one source VM. It applies only to messages that are sent to port 2888, the default port number that ZooKeeper uses for followers to connect to the leader. Thus, any other traffic originating from the sender VM would not be impacted by this rule. However, note that the rule does not specify a destination host. The tester can further specialize this rule by adding a destination MAC address to impact only traffic between two particular end host VMs.

This rule forwards all matching packets to the OpenFlow controller. The programmable controller, and thus the tester, can decide how to further process these packets. In our current implementation, the flow delay module, described below, processes these packets. If the tester wants to drop matching packets (modeling a communication loss), the rule would end in an empty actions command, as in “actions”:“ ”.

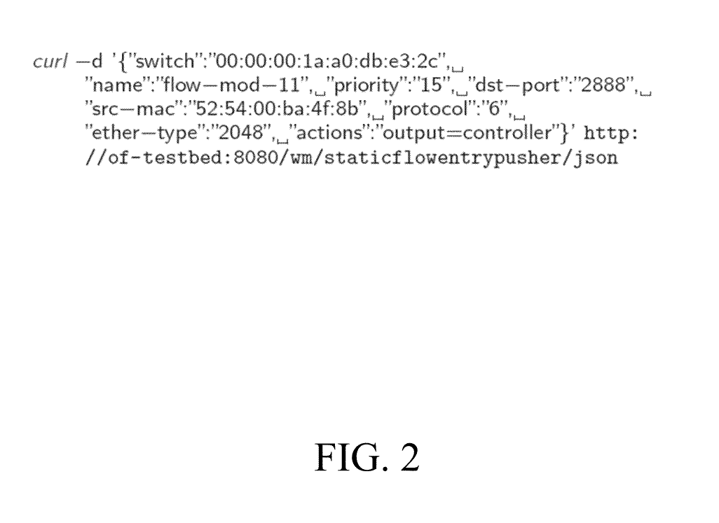

Finally, the tester can re-establish the connection by deleting the rule using another curl command, as shown in FIG. 2. Note that the deletion utilizes the name of the rule.

Wildcard Usage.

So far, we have presented how to use the OpenFlow protocol to selectively degrade individual communication links, between one source and one destination. The tester can thus affect large parts of the communication network by combining several updates to individual communication links. However, sometimes the tester wants to impact a large section of a network at once (requirement 1 a). For this, we use the OpenFlow protocol facility of wildcards.

The OpenFlow protocol allows use of wildcards in rule matching. Consider, for example, that all VMs for the switch on the left in FIG. 0 are assigned an IP in the range 192.168.10.0-255, whereas all VMs for the switch on the right are assigned an IP in the range 192.168.20.0-255. We can thus model a large-scale disconnect of the two switches by specifying that any traffic from 192.168.10.* to and from 192.168.20.* is impacted using only two rules.

4.2 Flow Delay Module

The FloodLight static flow pusher module allows our tester to control the behavior of one or many network communication flows between VMs. As discussed above, the tester can install rules that drop particular types of communication. The tester may thus observe the application behavior under complete or partial connectivity loss. Note that partial connectivity loss is likely to become a debugging issue as more application traffic is shaped by routing it through different virtual sub-networks.

While dropping packets is enough to model (partial) connectivity loss, we also want to test applications in congested network situations. To do so, we developed a new flow delay module in FloodLight. This module, implemented in under 200 lines of Java, accepts a configuration file that contains pertinent information about the application that is being tested. This information includes MAC addresses of the participating hosts/VMs, the relevant port numbers etc., which is used to generate the appropriate rule updates by the controller.

The tester configures the flow delay module by specifying a range of delays to be applied to matching packets (in ms) When a switch forwards a packet to the SDN controller, the flow delay module first checks whether this packet is part of a flow under test. If it is not, it will be processed by other standard FloodLight modules. Otherwise, the module randomly chooses a delay from within the specified range of delays. The module holds on to the current packet for the specified delay period, and releases it to continue its path to the destination. The tester can thus emulate network congestion or long routes for only the particular network flows of interest. By allowing the tester to specify a range of delays, the tester can not only check for congested networks but also increase the chance of packets arriving at the destination out-of-order.

5 Experiments

5.1 Implementation

We implemented the techniques on a server with two physical Intel Xeon processors, and each processor contains 4 cores. The server has 32 GB memory, and runs Ubuntu 12.04.1 with the virtualization library libvirt version 1.0.4. We use the Open vSwitch version 1.10.90, and the FloodLight controller using development version 0.90+. Each benchmarks described below was tested and analyzed in less than one work-day each.

5.2 Apache ZooKeeper

The Apache ZooKeeper project is a centralized service meant for maintaining high-level configuration information, providing distributed synchronization and group services. ZooKeeper provides a well-tested, industry-standard, open-source Java implementation that is used by many other distributed services or applications. The VMs use the current ubuntu ZooKeeper version 3.3.5+dfsg1-1ubuntu1. The official ZooKeeper project has currently two stable releases, which are release 3.3.6 and release 3.4.5.

5.2.1 Test Strategy

We use a ZooKeeper ensemble of three VMs. In ZooKeeper, an ensemble is regarded as being in a good state if at least a majority (here, two VMs) are communicating with each other, and they agree upon a leader amongst the connected VMs. When a leader becomes unresponsive, and if the other two follower-VMs are still in communication, they will re-elect a new leader amongst themselves. Should the third VM re-join the ensemble, it joins it as a follower.

As a proof-of-concept of our SDN test framework, we developed a naive random test strategy for ZooKeeper. Each VM runs a random sequence of ZooKeeper events, including stopping and then re-starting the ZooKeeper service, creating new elements in the shared configuration state, re-setting values, querying some states, or deleting some states. The tester randomly disconnects communication links, or re-routes them through the delay flow module, and re-connects them after some time. The rules that are installed and removed on the switches only apply to ZooKeeper messages. Since two ports are used for communication, one for leader election, and the other for following an elected leader, our random tester also decides whether to impact all ZooKeeper communications on a link or only one message type.

5.2.2 Resiliency Test Analysis

We performed initial experiments using the described test setup. Notably, we observe that many commands that are randomly executed as a work-load on some VM end with an uncaught KeeperException for reasons of communication loss. This is due of the fact, that our distributed work-loads do not check whether the VM is part of the ZooKeeper ensemble when a new command is started. Such executions are thus not a cause of concern, and are deemed recoverable errors in ZooKeeper's terminology (see http://wiki.apache.org/hadoop/ZooKeeper/ErrorHandling).

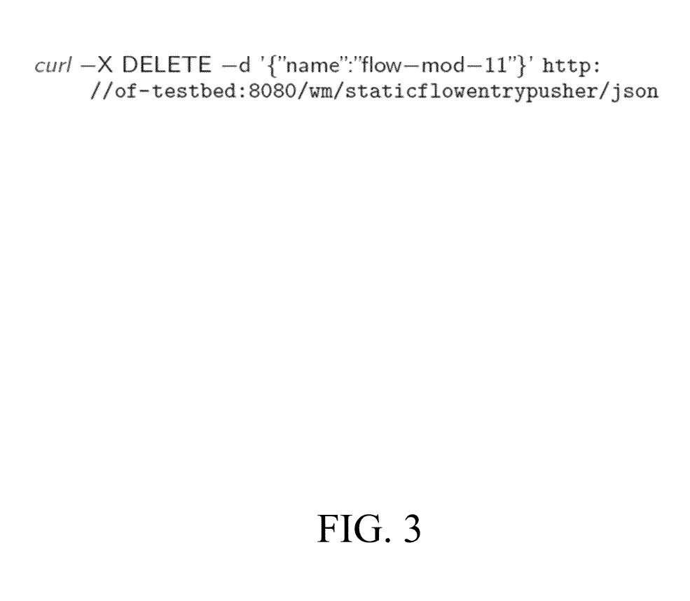

However, we also found four distinct types of issues that we believe require further investigation. One of these is a NULL-pointer exception in the current Ubuntu precise version of ZooKeeper, which has been fixed in the official stable version 3.4.5. We highlight part of the offending code in FIG. 3. Interestingly, the function call to zk.exist(.) may end with an exception or return NULL. The former is gracefully handled in an outer exception handler.

We also noted three instances where the ZooKeeper application fails abruptly in a fatal state or error state, because ZooKeeper ends up in an unrecoverable state. Note that we are testing the ZooKeeper service as the application, and thus unrecoverable errors where the system cannot return in a good state are a problem. We believe that at least one of these cases is still not resolved in the newest version.

6 Related Work

A related work with respect to distributed testing is the work by Lübke et al. on NESSEE [7]. They provide an architecture, based on Dummynet, that allows network emulation of systems with typical client/server-based architectures. The tool allows a tester to specify the network characterics in detail using an XML-based test description language. The main goal, as is common for standard network emulators, is to get precise and accurate performance measurements. Our initial goal is to find distributed application resiliency issues. We also address arbitrary distributed service architectures.

Generally, various stress testing or fault injection based methods are used to test for performance and robustness in applications. During stress testing, a test network is saturated with heavy load conditions. Typical stress testing tools are Selenium (http://seleniumhq.org) or LoadRunner by HP.

Random fault-injection based methods are also frequently used for distributed application resiliency testing, such as chaos monkey testing or GameDay exercises. To allow testers more control where faults should be injected, various test description languages have been proposed. One such example is the tool LFI by Marinescu and Candea for fault-injection based testing of recovery code when library calls fail [8]. A recent work also targets robustness/resiliency testing of cloud applications. It allows a tester to specify a desired testing policy using application-dependent abstraction labels that expose internal states of the system. This is more effective than black-box testing, but needs support through an application instrumentation and a scheduler that controls and manages the ordering of certain execution events. Here, we treat the applications as black boxes and design programmable modules for an SDN to exercise relevant network event orderings.

Some recent work discusses formal verification of OpenFlow modules [1, 3, 10] and testing of OpenFlow switches [6, 13]. Diagnosing and debugging of errors at the SDN level has also been investigated [15]. All these techniques target the verification and testing at the network level. We are instead using the SDN to test distributed cloud applications.

7 Directions

We proposed the use of software-defined networking for testing of distributed cloud applications. Our main goal is to find resiliency-related issues in distributed services that are due to network communication failures such as loss or degradation of connections. We showcase an implementation using the OpenFlow API and the FloodLight controller.

The current capabilities of the FloodLight flow delay module can be emulated precisely enough using network emulators. However, we note again the difference between emulating the communication and running it on an actual live network. We can also allow the tester even more control of the test scenarios. This includes the following extensions: systematic exploration of message orderings, network-level test statistics gathering, performance estimation, and combining SDN control with network emumators.

Systematic exploration of message orderings has been explored for fault injection in distributed services using FATE and DESTINI [4] and PreFail [5]. Performing such systematic exploration using a programmable SDN, however, does not require intrusive modifications to the application under test. Thus, we believe that developing further OpenFlow modules will allow us to target additional testing goals.

OpenFlow collects network traffic statistics on individual switches, which are communicated to the controller. The tester can use this information in combination with the choice to set desired lifetime lengths of installed rules during debugging.

We also foresee various use cases for a combination of programmable network control with network emulators. First, we can utilize this approach as an extension of distributed application testing for performance estimation. The tester can configure certain network characteristics captured by several instances of network emulators. The SDN-based test network can then dynamically change which traffic to route through these configured sub-network emulators. A second use case is to allow network emulators better scalability by distributing their workload onto multiple servers connected through an actual network. The additional advantage of using SDNs is that we can design a new SDN module that monitors the performance of the distributed emulation. The SDN module thus acts as a load balancer for network emulators by routing flows to underutilized emulation servers.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A network testing method implemented in a software-defined network (SDN), the network testing method comprising:
providing a test scenario including one or more network events;
injecting said one or more network events to the SDN using an SDN controller; and
gathering network traffic statistics.

2. The network testing method as in claim 1, wherein said one or more network events include a network connection loss, network connection degradation, dropping a packet, or delaying a packet.

3. The network testing method as in claim 1, wherein the injection is carried out dynamically.

4. The network testing method as in claim 1, wherein the network traffic statistics comprises how often an application tries to connect to a certain port on a destination host.

5. The network testing method as in claim 1, wherein the SDN network comprises an OpenFlow network and the SDN controller comprises an OpenFlow controller.

6. The network testing method as in claim 1, wherein the injection is carried out through OpenFlow application programming interface (API).

7. The network testing method as in claim 5, wherein injection is carried out using OpenFlow controller FloodLight comprising a static flow pusher module.

8. The network testing method as in claim 5, wherein the OpenFlow controller comprises a flow delay module, and said one or more network events include delaying a packet using the flow delay module.

9. The network testing method as in claim 8,
wherein the flow delay module accepts a configuration file that contains information about an application to be tested, and
wherein the information includes at least one of a media access control (MAC) address of a participating host or virtual machine (VM) and a port number, and information is used to generate a rule update.

10. The testing method as in claim 8, further comprising:
configuring the flow delay module by specifying a range of a delay to be applied to a matching packet;
checking whether a packet is part of a flow under test; and
if the packet is part of the flow under test, randomly choosing a delay from within the range.

11. A network testing apparatus used in a software-defined network (SDN), the network testing apparatus comprising:
a testing system to provide a test scenario including one or more network events, to inject said one or more network events to the SDN using an SDN controller, and to gather network traffic statistics.

12. The network testing apparatus as in claim 11, wherein said one or more network events include a network connection loss, network connection degradation, dropping a packet, or delaying a packet.

13. The network testing apparatus as in claim 11, wherein the injection is carried out dynamically.

14. The network testing apparatus as in claim 11, wherein the network traffic statistics comprises how often an application tries to connect to a certain port on a destination host.

15. The network testing apparatus as in claim 11, wherein the SDN network comprises an OpenFlow network and the SDN controller comprises an OpenFlow controller.
